(19) United States
(12) Patent Application Publication
(10) Pub. No.: US 2008/0075525 A1
(43) Pub. Date: Mar. 27, 2008

(54) Nail Polish Applicator

(76) Inventor: Abagail Lewis, Derby, KS (US)

Correspondence Address: HOVEY WILLIAMS LLP, Suite 400, 2405 Grand, Kansas City, MO, 64108, US

(21) Appl. No.: 11/534,703

(22) Filed: Sep. 25, 2006

(51) Int. Cl. A46B 11/04; B43K 5/06; A47L 13/22

(52) U.S. Cl. 401/270; 401/275; 401/179

(57) ABSTRACT

A nail polish applicator that can be easily held and operated with one hand and that consistently dispenses a controlled amount of nail polish comprises an elongated tubular housing including a reservoir for holding a quantity of nail polish; an applicator attached to one end of the housing for applying the nail polish to the user's fingernails or toenails; and a dispensing mechanism for dispensing the nail polish from the reservoir to the applicator. The dispensing mechanism includes an elongated slot formed in the sidewall of the housing, a slider or other manually manipulatable button movable within the slot, and a plunger mechanism attached to the button for incrementally dispensing the nail polish from the reservoir when the button is moved within the length of the slot.

### BACKGROUND OF THE INVENTION

1. Field of the Invention

The present invention relates to nail polish applicators. More particularly, the invention relates to a nail polish applicator that can be easily held and operated with one hand and that consistently dispenses a known and controlled amount of nail polish.

2. Description of the Prior Art

Nail polish is typically supplied in small plastic bottles and applied with a brush attached to the bottle's screw-on cap. To apply the polish, the user first removes the cap and attached brush and removes excess polish from the brush by wiping the brush along the inside wall of the nail polish bottle. The user then strokes the brush across one or more fingernails or toenails to transfer the polish from the brush to the nails. When additional polish is needed, the user must again dip the brush into the bottle, wipe off excess polish, and apply the polish to her nails. Application of nail polish in this manner requires the use of two hands and repeated re-wetting of the brush, risking contact between wet nails and the bottle or nearby objects that may smear the recently applied polish. These steps are also time-consuming and messy because the bottles are often tipped over and the brushes are frequently dropped. Many users, especially children, often spill or smear the nail polish on furniture, clothing, carpet, and other objects.

Nail polish is formulated to dry quickly to enable the wearer to resume normal activities as soon as possible. Unfortunately, the quick-drying formulation causes the nail polish in an open bottle to dry out, too. Polish in a bottle which has been open too long or is old tends to thicken, making future applications more difficult. Dried polish in a bottle and on the cap's brush also interferes with future applications of polish and with closure of the bottle. It is therefore often necessary to dispose of a bottle of nail polish before it is empty because the remaining polish is too thick or the bottle is too difficult to reopen.

Nail polish applicators of various configurations have been developed to partially solve some of the above-described problems. However, known nail polish applicators are too complicated, expensive and/or difficult to use. A particular problem of known nail polish applicators is that they cannot be easily held and operated with one hand. Another problem with known nail polish applicators is that they do not dispense nail polish in a consistent and controlled manner.

Accordingly, there is a need for an improved nail polish applicator that overcomes the limitations of the prior art.

### SUMMARY OF THE INVENTION

The present invention solves the above-described problems and provides a distinct advance in the art of nail polish applicators. More particularly, the present invention provides a nail polish applicator that can be easily held and operated with one hand and that consistently dispenses a controlled amount of nail polish. One embodiment of the nail polish applicator broadly comprises an elongated tubular housing including a reservoir for holding a quantity of nail polish; an applicator attached to one end of the housing for applying the nail polish to the user's fingernails or toenails; and a dispensing mechanism for dispensing the nail polish from the reservoir to the applicator.

The dispensing mechanism is advantageously configured so that a user may grip the housing, operate the dispensing mechanism, and apply the dispensed nail polish with only one hand. The dispensing mechanism is also advantageously configured to consistently dispense a known and controlled amount of nail polish with each incremental movement of the dispensing mechanism. The preferred dispensing mechanism broadly includes an elongated slot formed in the sidewall of the housing, a slider or other manually manipulatable button movable within the slot, and a plunger mechanism attached to the button for incrementally dispensing the nail polish from the reservoir when the button is moved within the length of the slot.

These and other important aspects of the present invention are described more fully in the detailed description below.

### BRIEF DESCRIPTION OF THE DRAWING FIGURES

A preferred embodiment of the present invention is described in detail below with reference to the attached drawing figures, wherein:

FIG. 1 is an isometric view of a nail polish applicator constructed in accordance with a preferred embodiment of the present invention.

FIG. 2 is a partially exploded and partial vertical cross-sectional view of the nail polish applicator of FIG. 1.

FIG. 3 is a vertical cross-sectional view of the nail polish applicator of FIG. 1 showing the nail polish dispensing mechanism in its fully retracted position and showing the applicator end of the nail polish applicator covered by a cap.

FIG. 4 is a vertical cross-sectional view of the nail polish applicator of FIG. 1 showing the nail polish dispensing mechanism in its fully extended position with the cap removed.

FIG. 5 is an isometric view of a nail polish applicator constructed in accordance with another embodiment of the present invention.

FIG. 6 is a partially exploded and partial vertical cross-sectional view of the nail polish applicator of FIG. 5.

FIG. 7 is a vertical cross-sectional view of the nail polish applicator of FIG. 5 showing the nail polish dispensing mechanism in its fully retracted position and showing the applicator end of the nail polish applicator covered by a cap.

FIG. 8 is a vertical sectional view of the nail polish applicator taken along line 8-8 of FIG. 7.

FIG. 9 is a vertical cross-sectional view of the nail polish applicator of FIG. 5 showing the nail polish dispensing mechanism in its fully extended position with the cap removed.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE PREFERRED EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

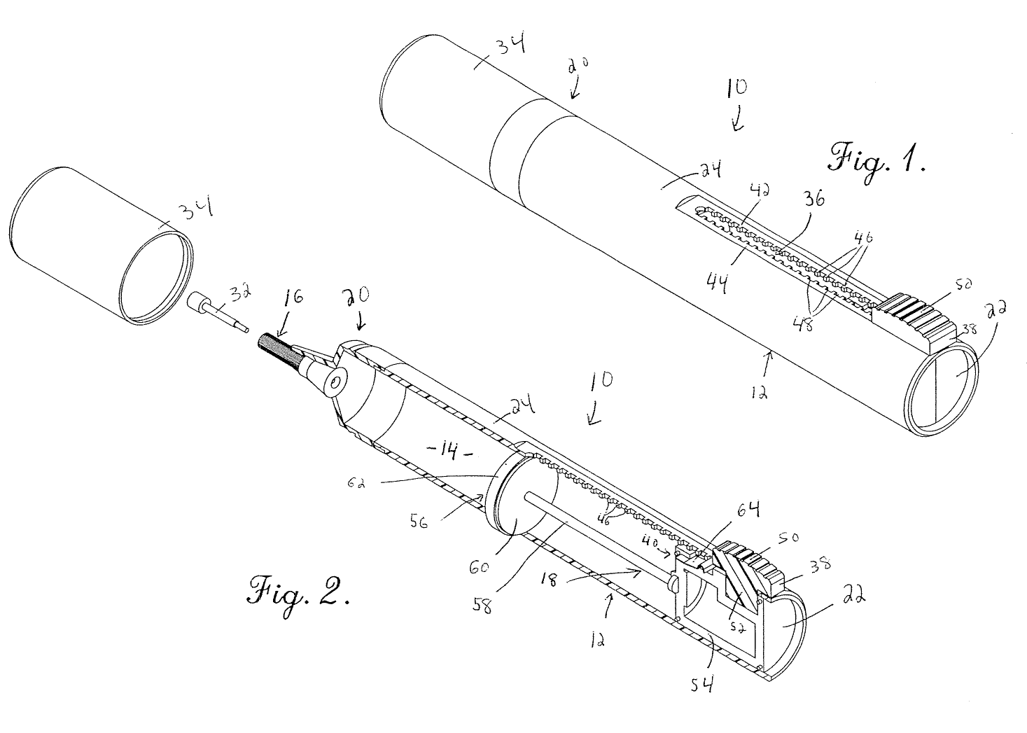

Turning now to the drawing figures, and particularly FIGS. 1 and 2, a nail polish applicator 10 constructed in accordance with a preferred embodiment of the invention is illustrated. The nail polish applicator 10 is operable for containing and dispensing nail polish so that a user may conveniently apply the polish to her fingernails or toenails. The nail polish applicator 10 broadly comprises an elongated tubular housing 12 including a reservoir 14 for holding a quantity of nail polish; an applicator 16 attached to one end of the housing for applying the nail polish to the user's fingernails or toenails; and a dispensing mechanism generally referred to by the numeral 18 for dispensing the nail polish from the reservoir to the applicator.

In more detail, the housing 12 is preferably tubular and includes an applicator end 20 to which the applicator 16 is attached, a distal end 22 axially spaced from the applicator end, and a cylindrical sidewall 24 extending between the applicator end and the distal end. The housing is preferably molded from plastic or other synthetic resin materials, but may be formed of any other suitable material such as aluminum or fiberglass. In preferred forms, however, the housing is formed from inexpensive materials so that it may be thrown away after the nail polish is fully dispensed therefrom. In one embodiment, the housing is between 4-6″ in length and ¼-½″ in diameter, but it may be of other dimensions without departing from the scope of the invention.

The reservoir 14 is preferably positioned near the applicator end 20 of the housing. In one embodiment, the reservoir is sized to hold approximately 0.8 oz. of nail polish, but it may be sized to hold anywhere between 0.2 and 2 oz. of nail polish. The portion of the housing sidewall that defines the reservoir may be transparent so that the color and remaining quantity of nail polish in the reservoir can be easily ascertained.

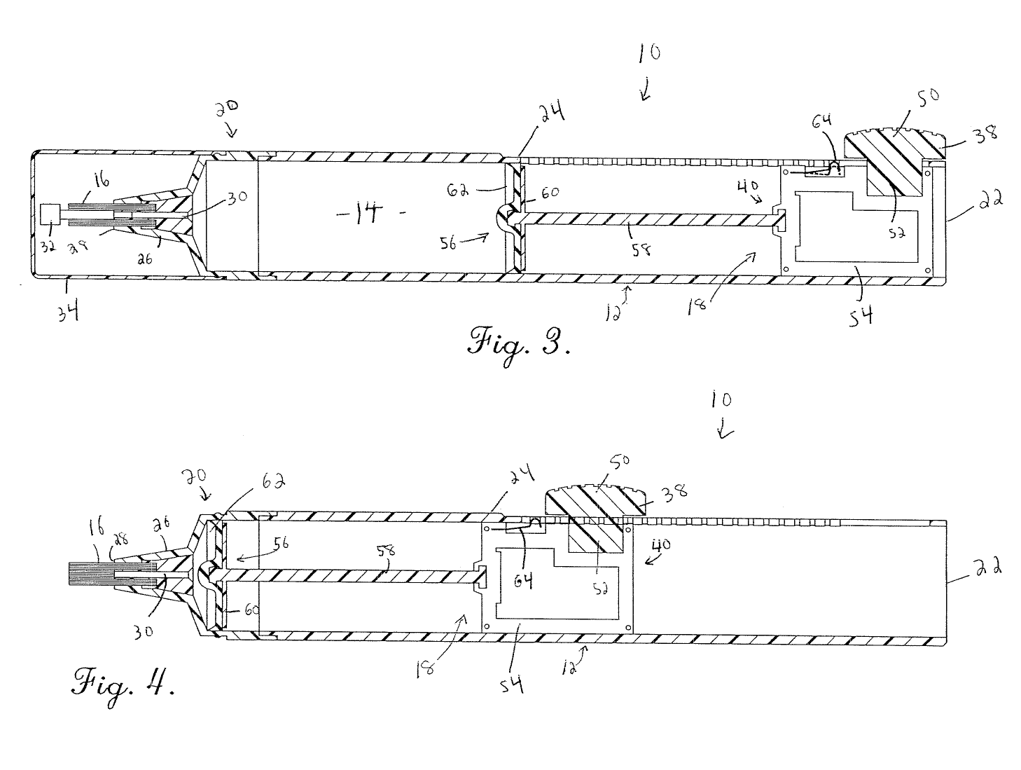

As best illustrated in FIGS. 3 and 4, the applicator end 20 of the housing tapers inwardly to form a nozzle 26 having an outermost tip 28. A relatively small diameter fluid passageway 30 extends through the center of the nozzle and is in fluid communication with the reservoir 14 to permit the nail polish to flow from the reservoir to the tip of the nozzle.

The applicator 16 is attached to the nozzle 26 and is used to evenly apply dispensed polish to the user's nails. In one embodiment, the applicator is a small brush that extends beyond the tip 28 of the nozzle 26. In other embodiments, the applicator may consist of a sponge or any other make-up applicator or other device that can be used to evenly spread the dispensed nail polish. The applicator may be fixed to the nozzle or configured so that it is removable so that it may be replaced with a different applicator. The nail polish applicator 10 may be supplied with several removable applicators of various sizes and made of various materials so that the user may select which applicator is desired.

The nail polish applicator 10 also preferably includes a stopper 32 which may be inserted in the passageway 30 when the applicator 10 is not being used. This prevents nail polish from dripping from the nozzle 26 and prevents outside air from drying the nail polish in the reservoir 14. A cap 34 may also be provided to cover the nozzle 26 and applicator 16 when not in use to further inhibit air from entering the reservoir 14 and to prevent unwanted contact between the applicator 16 and external objects.

The dispensing mechanism 18 dispenses the nail polish from the reservoir 14 to the applicator 16. In accordance with an important aspect of the present invention, the dispensing mechanism is configured so that a user may grip the housing 12, operate the dispensing mechanism, and apply the dispensed nail polish with only one hand. In accordance with another important aspect of the invention, the dispensing mechanism is configured to consistently dispense a known and controlled amount of nail polish from the reservoir. As best illustrated in FIGS. 1 and 2, the preferred dispensing mechanism 18 broadly includes an elongated slot 36 formed in the housing sidewall 24, a slider or other manually manipulatable button 38 movable within the slot 36, and a plunger mechanism generally referred to by the numeral 40 attached to the button for incrementally dispensing the nail polish from the reservoir when the button is moved within the slot.

In more detail, the slot 36 preferably extends from near the distal end 22 of the housing to approximately the midpoint of the housing. The slot includes a pair of oppositely disposed sides 42, 44 each presenting a series of spaced teeth 46 which define a series of spaced notches 48. Each pair of oppositely disposed notches on the sides 42, 44 form a stop for the button 38 as described in more detail below.

The button 38 is movable within the slot 36 between a fully retracted position illustrated in FIG. 3 and a fully extended position illustrated in FIG. 4. The button 38 includes a grip portion 50 external to the housing and a stem 52 extending through the slot into the interior of the housing. The grip portion is sized and configured for manipulation by the user's thumb, and the stem connects the grip portion to the plunger mechanism 40.

The plunger mechanism 40 is attached to the button 38 and is located within the housing. The preferred plunger mechanism includes a cylindrical plug 54 movable within the housing 12 and attached to the stem 52 of the button 38, a plunger 56 for pushing nail polish from the reservoir 14 out the passageway 30, and a rod 58 connecting the plunger to the plug.

The plug 54 is sized and shaped to fit within the hollow confines of the housing 12 and is movable between a fully retracted position illustrated in FIG. 3 and a fully extended position illustrated in FIG. 4. As best illustrated in FIG. 3, the plunger 56 includes a circular base plate 60 integrally formed with or otherwise attached to one end of the rod 58 and a rubber disc 62 supported on the reservoir side of the base plate. The rubber disc serves as a squeegee to push nail polish from the reservoir out the nozzle while preventing the nail polish from migrating into the portion of the housing enclosing the plunger mechanism. As with the button 38 and the plug 54, the plunger 56 is movable in the housing between a fully retracted position shown in FIG. 3 and a fully extended position show in FIG. 4.

A spring metal catch 64 is attached to the plug 54 and configured so that it moves within the slot 36 along with the button 38. The catch 64 is sized and shaped to be received within the stops formed from pairs of oppositely disposed notches 48 in the slot. As shown in FIG. 3, one end of the catch is fixed to the plug, but the other end is unattached so that the catch biases downward and slides underneath the teeth 46 (as shown by the dashed lines in FIG. 3) when the button 38 is moved along the length of the slot. After passing under a set of teeth, the catch springs back up to be received within another set of oppositely disposed notches of the slot. This permits the button to be selectively moved to one of a plurality of discrete positions within the slot to incrementally dispense the nail polish from the reservoir. Each time the catch snaps into a pair of notches, it creates an audible clicking sound.

In the illustrated embodiment, the slot 36 includes 21 pairs of oppositely disposed notches to form 21 stops for the button 38. Thus, each discrete movement of the button dispenses approximately 1/21th of the volume of nail polish within the reservoir 14. For a reservoir volume of 0.8 oz., each discrete movement of the button therefore dispenses approximately 0.038 oz. of nail polish. Other embodiments of the nail polish applicator 10 may include as few as 5 pairs and as many as 40 pairs of oppositely disposed notches.

The reservoir 14 of the nail polish applicator 10 is preferably pre-filled with a quantity of nail polish before it is sold to the user. However, the applicator 10 may also be sold empty and loaded with nail polish by a consumer by moving the button 38 to its fully extended position illustrated in FIG. 4, dipping the nozzle 26 in a bottle or other source of nail polish, and then slowly retracting the button to its fully retracted position illustrated in FIG. 3 to suck nail polish into the reservoir with the plunger mechanism 40.

To use the nail polish applicator 10, a person first removes the cap 34 and stopper 32 and then grips the housing 12 between her fingers and thumb of one hand. The user then places the applicator 16 near a fingernail or toenail to be painted and moves the button 38 to one of the stops within the slot 36 to begin to dispense nail polish from the reservoir.

As the user begins to paint her nails, she may continue to move the button 38 further from its fully retracted position shown in FIG. 3 to dispense more nail polish from the reservoir 14. The shiftable catch 64 and the corresponding pairs of notches allow the user to move the button a discrete distance to provide a measured and controlled flow of nail polish out of the reservoir. For example, through experimentation, a user may determine that moving the button through three pairs of notches (or any other number) dispenses the optimum amount of nail polish to cover one nail. The user may therefore simply move the button 38 with her thumb until she hears three clicks from the shiftable catch. This permits the user to consistently and quickly dispense the exact desired amount of nail polish from the device without even looking at the button or any other component of the nail polish applicator so the user may concentrate on evenly applying the dispensed polish to her nails.

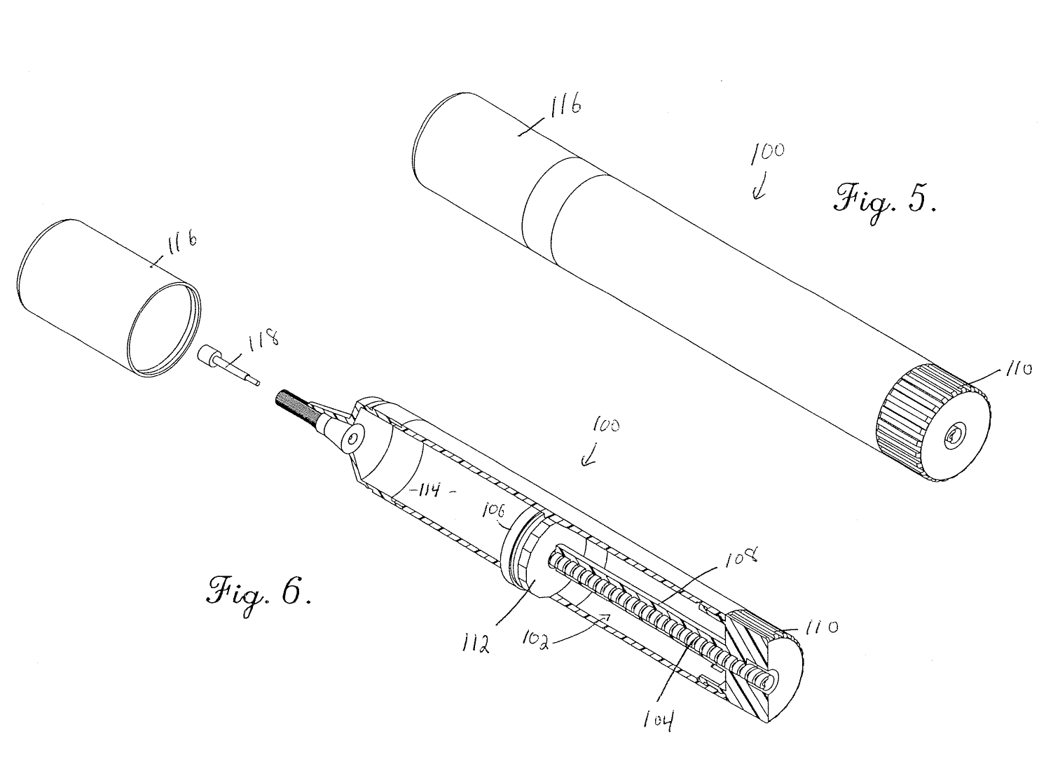

FIGS. 5-9 illustrate a nail polish applicator 100 constructed in accordance with an alternative embodiment of the invention. The nail polish applicator 100 is similar to the nail polish applicator 10 of FIGS. 1-4 except that it includes a different dispensing mechanism. The dispensing mechanism of the alternate embodiment is generally referred to by the numeral 102 and includes a threaded rod 104 attached to a plunger 106 and a complementary internally threaded tube 108. One end of the threaded tube 108 is attached to a rotatable dial 110 positioned on the distal end of the housing. The opposite end of the threaded tube is attached to a support ring 112 positioned within the housing.

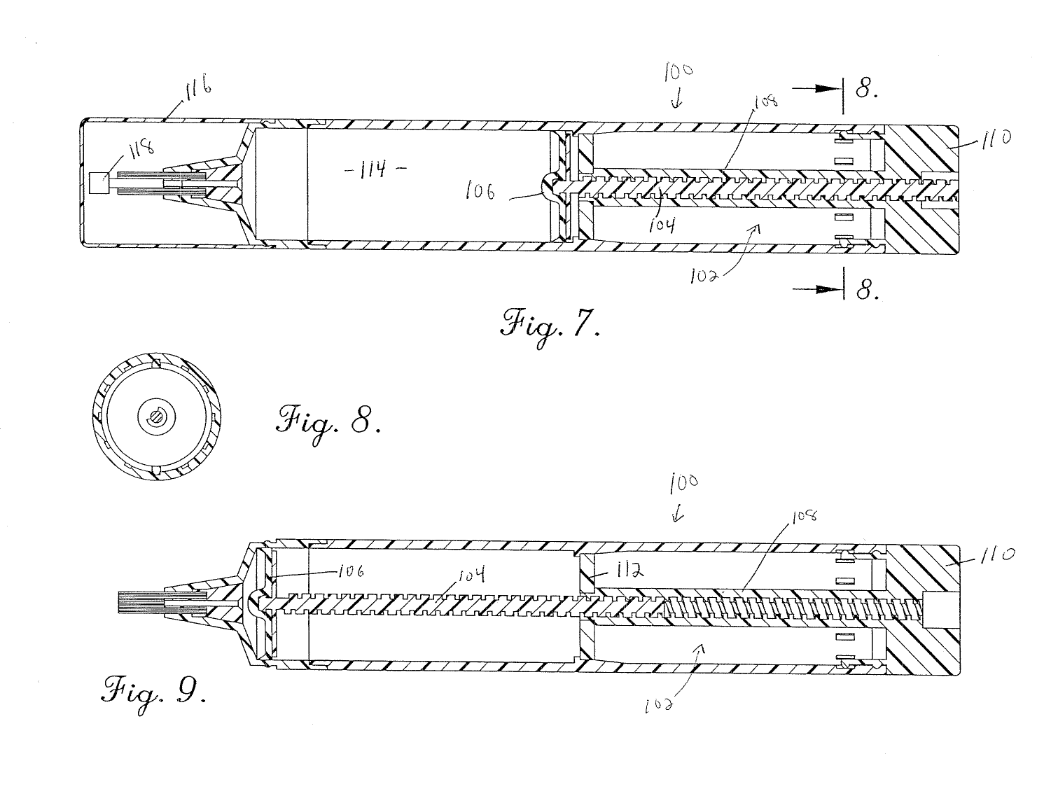

The dispensing mechanism 102 is initially in the position illustrated in FIG. 7 when the reservoir 114 is fully loaded with nail polish. The user may then remove the cap 116 and stopper 118 and then rotate the dial in a clockwise direction (or a counterclockwise direction depending on the orientation of the threadings on the rod and tube) to dispense nail polish from the reservoir. Rotation of the dial also rotates the threaded tube, causing the threaded rod and attached plunger to move toward the position illustrated in FIG. 9. Once all of the nail polish has been dispensed from the reservoir, the dispensing mechanism will be in its fully extended position of FIG. 9.

The nail polish applicator 100 is similar to a prior art eye-liner applicator except that has it has been modified to specifically dispense and apply nail polish. The nail polish applicator 10 of FIGS. 1-4 is preferred to the nail polish applicator 100 of FIGS. 5-9 because the nail polish applicator 10 is easier to hold and operate with one hand and more effectively dispenses a controlled and known quantity of nail polish from its reservoir.

Although the invention has been described with reference to the preferred embodiment illustrated in the attached drawing figures, it is noted that equivalents may be employed and substitutions made herein without departing from the scope of the invention as recited in the claims. For example, the particular size, shape and construction materials of the various embodiments of the nail polish applicator may be altered without departing from the scope of the invention.

Having thus described the preferred embodiment of the invention, what is claimed as new and desired to be protected by Letters Patent includes the following:

1. A nail polish applicator comprising:
an elongated housing having a reservoir for holding a quantity of nail polish;
an applicator attached to one end of the housing for applying the nail polish to a user's fingernails; and
a dispensing mechanism for dispensing a portion of the nail polish from the reservoir to the applicator, the dispensing mechanism including a manually manipulatable button which incrementally dispenses the nail polish from the reservoir to the applicator, the button being positioned so that a user may grip the housing, operate the button, and apply the nail polish using only one hand.

2. The nail polish applicator as set forth in claim 1, wherein the elongated housing includes an applicator end to which the applicator is attached, a distal end axially spaced from the applicator end, and a cylindrical sidewall extending between the applicator end and the distal end, the button being positioned on the sidewall so that the user may grip the housing near the applicator end with the user's finger and simultaneously operate the button with the user's thumb to incrementally dispense the nail polish from the reservoir to the applicator.

3. The nail polish applicator as set forth in claim 1, wherein the dispensing mechanism further includes an elongated slot formed in the housing sidewall, the button being moveable within the slot to incrementally dispense the nail polish from the reservoir to the applicator.

4. The nail polish applicator as set forth in claim 3, wherein the slot includes a pair of oppositely disposed sides each presenting a series of spaced teeth which define a series of spaced notches.

5. The nail polish applicator as set forth in claim 4, the dispensing mechanism further including a catch attached to the button and sized and shaped to be received within pairs of oppositely disposed notches in the slot.

6. The nail polish applicator as set forth in claim 5, wherein the dispensing mechanism further includes a plug moveable within the housing and attached to the button, an elongated rod attached to one end of the plug, and a plunger attached to an end of the rod for pushing the nail polish from the reservoir to the application when the button is moved in the slot.

7. The nail polish applicator as set forth in claim 1, the housing including a nozzle having a fluid passageway in fluid communication with the reservoir.

8. The nail polish applicator as set forth in claim 7, further including a stopper for insertion within the fluid passageway of the nozzle when the nail polish applicator is not in use for substantially sealing the reservoir.

9. The nail polish applicator as set forth in claim 8, further including a removable cap for covering the applicator and the nozzle when the nail polish applicator is not in use.

10. The nail polish applicator as set forth in claim 1, wherein the applicator is selected from the group consisting of a brush, a sponge, and a make-up applicator.

11. A nail polish applicator comprising:
an elongated housing having a reservoir for holding a quantity of nail polish, the housing including an applicator end, a distal end axially spaced from the applicator end, and a cylindrical sidewall extending between the applicator end and the distal end;
a brush attached to the applicator end of the housing for applying the nail polish to a user's fingernails; and
a dispensing mechanism for dispensing a portion of the nail polish from the reservoir to the brush, the dispensing mechanism including a slot formed in the cylindrical sidewall of the housing and a manually manipulatable button moveable within the slot, the dispensing mechanism being configured to incrementally dispense the nail polish from the reservoir to the brush as the button is moved within the slot.

12. The nail polish applicator as set forth in claim 11, wherein the slot includes a pair of oppositely disposed sides each presenting a series of spaced teeth which define a series of spaced notches.

13. The nail polish applicator as set forth in claim 12, the dispensing mechanism further including a catch attached to the button and sized and shaped to be received within pairs of oppositely disposed notches in the slot.

14. The nail polish applicator as set forth in claim 13, wherein the dispensing mechanism further includes a plug moveable within the housing and attached to the button, an elongated rod attached to one end of the plug, and a plunger attached to an end of the rod for pushing the nail polish from the reservoir to the application when the button is moved in the slot.

15. The nail polish applicator as set forth in claim 11, the housing including a nozzle having a fluid passageway in fluid communication with the reservoir.

16. The nail polish applicator as set forth in claim 15, further including a stopper for insertion within the fluid passageway of the nozzle when the nail polish applicator is not in use for substantially sealing the reservoir.

17. The nail polish applicator as set forth in claim 16, further including a removable cap for covering the applicator and the nozzle when the nail polish applicator is not in use.
